(19) United States
(12) Patent Application Publication
(10) Pub. No.: US 2023/0276187 A1
(43) Pub. Date: Aug. 31, 2023

(54) SPATIAL INFORMATION ENHANCED AUDIO FOR REMOTE MEETING PARTICIPANTS

(71) Applicant: Lenovo (United States) Inc., Morrisville, NC (US)

(72) Inventors: Tin-Lup Wong, Chapel Hill, NC (US); David W. Douglas, Cary, NC (US); Koji Kawakita, Yokohama City (JP); Kazuo Fujii, Yokohama City (JP)

(21) Appl. No.: 17/683,122

(22) Filed: Feb. 28, 2022

(51) Int. Cl. H04S 7/00; H04R 1/40; G10L 19/008

(52) U.S. Cl. CPC H04S 7/304; H04R 1/406; G10L 19/008; H04S 2420/11

(57) ABSTRACT

A computer implemented method includes receiving sound at multiple microphones of a microphone array from multiple people at various locations about the microphone array. The received sound is encoded in at least one format capable of representing spatial locations of the multiple people. The encoded sound is transmitted in the at least one format to a remote user system capable of rendering the sound in a manner that conveys the spatial locations to a user of the remote user system.

### BACKGROUND

During a meeting in a room, such as a conference room, participants in the room can perceive where sound is coming from in the room. When a person speaks in the room, others in the room have visual and audio cues enabling them to locate the person speaking. Some of the ability to locate the person speaking may be due to differences in sound intensity and a difference in time of flight of the sound arriving at the ears of the others in the room. Remote participants receiving audio, however, may only be able to locate the person speaking based on visual cues from video information transmitted, if any.

### SUMMARY

A computer implemented method includes receiving sound at multiple microphones of a microphone array from multiple people at various locations about the microphone array. The received sound is encoded in at least one format capable of representing spatial locations of the multiple people. The encoded sound is transmitted in the at least one format to a remote user system capable of rendering the sound in a manner that conveys the spatial locations to a user of the remote user system.

### BRIEF DESCRIPTION OF THE DRAWINGS

FIG. 1 is a block representation of a local environment for hosting an electronic conference. according to an example embodiment.

FIG. 2 is a flowchart of a computer implemented method of encoding sound with spatial location information according to an example embodiment.

FIG. 3 is a flowchart of an alternative computer implemented method of encoding sound with spatial location information according to an example embodiment.

FIG. 4 is a flowchart of a further alternative computer implemented method of encoding sound with spatial location information according to an example embodiment.

FIG. 5 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable: instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Humans can locate sounds in three dimensions including range (distance), in directions above and below (elevation), in front and to the rear, as well as to either side (azimuth). This is possible because the brain, inner ear and the external ears work together to make inferences about location.

Humans estimate the location of a source by comparing cues received at both ears (difference cues or binaural cues). Among the difference cues are time differences of arrival and intensity differences.

Remote participants in an electronic conference receive sound captured in a conference room by one or more microphones. The sound is basically monaural and provides no remote participant discernable information regarding the spatial location of local participants in the conference room. Remote user experience a meeting differently than the local participants. As remote participation has been increasing, it is desirable to enhance the experience of the remote participants in meetings,

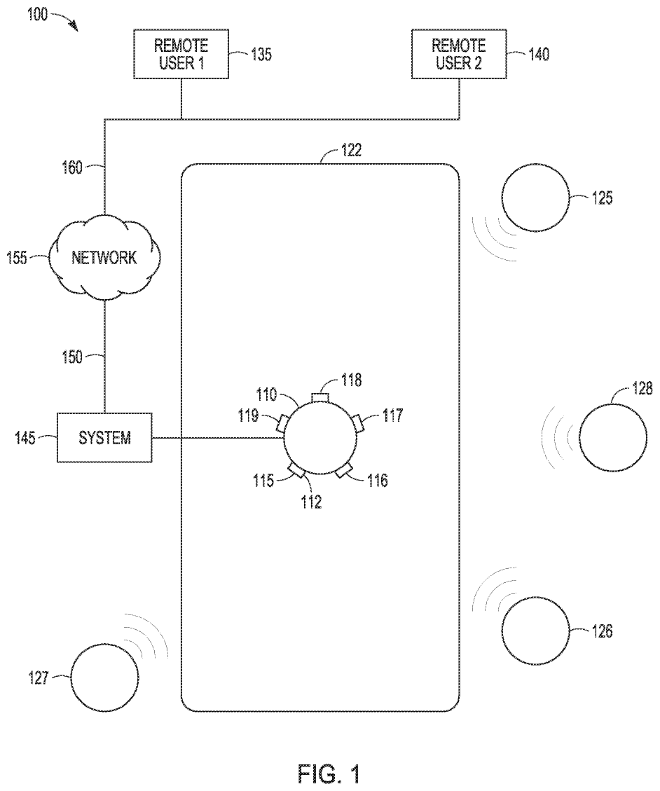

FIG. 1 is a block representation of a local environment 100 for hosting an electronic conference. An improved electronic conferencing hub device 110 includes a microphone array 112 that includes multiple spaced apart microphones 115, 116, 117, 118, 119, and 120 positioned around a circumference of the hub device 110. The hub device 110 may, be a ThinkSmart® device, a notebook computer, a sound bar, or wide field of view camera with processing circuitry in various examples. The hub device 110 may be positioned on a conference table 122 or elsewhere within the environment/conference room 100.

The microphone array 112 is configured to capture sound from one or more local participants 125, 126, 127, and 128 that are spatially dispersed about the hub device 110. The hub device 110 includes one or more algorithms to capture and encode audio sources in such a way as to maintain the sense of localization or spatial separation. The captured sound is encoded in one or more electronic format representations and sent to one or more remote participant devices 135 and 140 corresponding to first and second users that may be participating in the electronic conference. The remote devices 135 and 140 render the sound in a manner that provides sound from which remote participants can perceive spatial cues regarding the spatial locations of the local participants.

For remote participants listening with headphones, the hub device 110 captures a binaural recording of local participants that may be in the environment 100, such as a conference room. The hub device 110 may be coupled to a system 145 that may further be coupled via a network connection 150 to a network 155 for transmitting the representations of the captured sound to the remote participant devices 135 and 140 via one or more connections 160, such as an internet or cellular connection. In a further example, the hub device 110 may incorporate the system 145. The hub device 110 and system 145 may also divide processing tasks such as the encoding and transmission in further examples.

In one example, the hub 110 performs binaual recording of the received sounds. Binaural recording is a method of recording sound that uses at least two microphones to create an encoding of the sound that provides a spatial sensation for a remote participant listener, so that the listener may have a sensation of actually being in the room with the local participants. Binaural recording is intended for rendering using headphones.

In one example, Vector Base Amplitude Panning (\/BAP) may be used to give a directionally robust auditory event localization for sound sources.

The device hub 110 or system 145 can convert local sounds in real time. Real-time audio conversion of local sounds captured by the microphone array 112 may use Head Related Transfer Function (HRTF) filters to characterize how an ear receives a sound from a point in space. As sound strikes the listener, the size and shape of the head, ears, ear canal, density of the head, size and shape of nasal and oral cavities, all transform the sound and affect how it is perceived, boosting some frequencies and attenuating others. Generally speaking, the HRTF may boost frequencies from 2-5 kHz with a primary resonance of +17 dB at 2700 Hz.

A pair of HRTFs for two ears can be used to synthesize a binaural sound that seems to come from a particular point in space, describing how a sound from a specific point will arrive at the ear.

In one example, the electronic format representation is an object-based representation such as MPEG-H 3D audio streams. Object-based audio encodes audio sources as objects with meta-data that describes the microphone's placement in 3D space. Each object may include an object waveform and metadata, such as object position, gain, etc. Gain metadata may be used to normalize sound levels by increasing the gain of far field objects, such as local participant 125 and 127 who may be further away from huh device 112 than participants 126 and 128.

In this sound mixing method, audio clips can be treated as objects and moved anywhere in a 3600 space, as opposed to being sent to a speaker in a fixed position. This works through algorithms that divide the sound between several directional speakers.

With application specific plug-ins to support the decode, remote participant devices where users are using a set of headphones can hear the spatial separation of those in the conference room.

For remote participant devices having at least two speakers, the electronic format representation may include a format that allows rendering of the spatial scene that is not dependent on playback speaker setup (channel-based) or use of headphones (object-based).

Higher order ambisonics (HOA) may be used for remote devices with such speakers. ambisonics is a full-sphere surround sound format: in addition to the horizontal plane, it covers sound sources above and below the listener.

Unlike some other multichannel surround formats, transmissions do not include speaker signals. Instead, the transmissions contain a speaker-independent representation of a sound field called B-format, which is then decoded to the remote device's speaker setup. This extra step allows the encoding of the sound received by the speaker array to include representations of source directions rather than speaker positions and offers the listener at a remote device a considerable degree of flexibility as to the layout and number of speakers used for playback. Several coefficient signals may be used to represent a 3D spatial sound scene (spherical expansion).

The format of the transmitted representations of the captured sound may be negotiated with the remote devices 135 and 140 with the negotiated format being transmitted to each respective remote device. In one example, multiple formats may be transmitted, with the transmission either indicated with the transmission or determined by the remote device. The remote participants can then hear the spatial separation of the meeting room participants during the conference call.

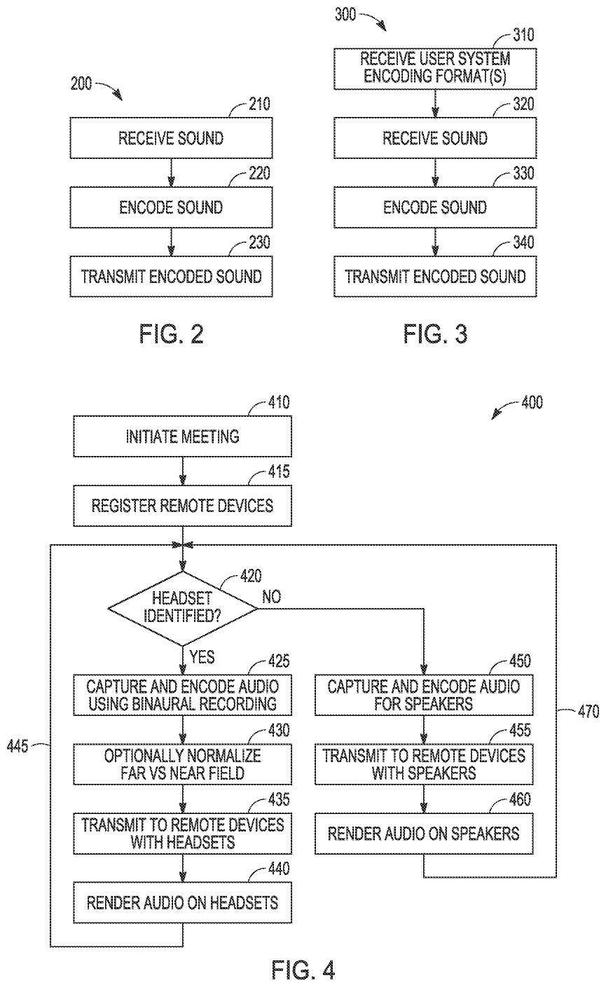

FIG. 2 is a flowchart of a computer implemented method 200 of capturing and transmitting sound in a room during an electronic conference call such that remote users receive sound representative of spatial positions of local attendees in the room. Method 200 begins in one example at operation 210 by receiving sound at multiple speakers of a speaker array from multiple people at various locations in a room.

The received sound is encoded at operation 220 in at least one format capable of representing spatial locations of the multiple people. In various examples, the sound in encoded in an object-based format. The encoding may be a binaural recording format using a VBA algorithm or using higher order ambisonics (HOA).

The encoding may further include normalizing far field and near field sound gain. Encoding the sound in at least one format capable of representing the spatial locations may include encoding the sound into multiple different formats corresponding to speaker playback and headphone playback.

At operation 230, the encoded sound is transmitted in the at least one format to a remote user system capable of rendering the sound in a manner that conveys the spatial locations of the received sounds to a user of the remote user system. Transmitting the encoding sound in the at least one format to a remote user system includes transmitting the multiple different formats to the remote user system along with identifiers of the multiple different formats to allow the remote user system to select one of the multiple formats for rendering consistent with an audio setup of the remote user system. The transmission may be made to multiple remote user systems which select the format corresponding to their corresponding audio configuration.

FIG. 3 is a flowchart of an alternative computer implemented method 300 of capturing and transmitting sound in a room during an electronic conference call such that remote users receive sound representative of spatial positions of local attendees in the room. Method 300 begins in one example at operation 310 by receiving information identifying a first encoding format corresponding to a remote user system. At operation 320, sound is received at multiple microphones of a microphone array from multiple people at various locations in a room. The received sound is encoded at operation 330 in the first encoding format that is capable of representing spatial locations of the multiple people. At operation 340, the encoded sound is transmitted in the first format to the remote user system capable of rendering the sound in a manner that conveys the spatial locations of the received sounds to a user of the remote user system.

In one example, indications received identify additional remote user system specific encoding formats for multiple additional remote user systems. The sound is encoded in each of the received additional remote user system specific encoding formats. The corresponding additional remote user system specific encoding formats are transmitted to each of the additional remote user systems.

FIG. 4 is a flowchart of yet a further alternative computer implemented method 400 of capturing and transmitting sound in a room during an electronic conference call such that remote users receive sound representative of spatial positions of local attendees in the room. The operations of method 400 may be executed by a hub device or a combination of the hub device and connected system or cloud devices. Further operations may be performed by remote devices.

Method 400 begins in one example at operation 410 by initiating a meeting that includes local participants in a conference room with a hub device for capturing sound via a microphone array. The meeting may also include remote participants using remote devices that connect to the hub device via any of multiple different types of networks capable of transferring audio and optionally visual information. The hub device may also include one or more speakers or speaker outputs for playing sound received from the remote devices.

At operation 415, the remote devices may be registered to the meeting. Registration may include receiving or accessing information identifying an audio configuration of each remote device. The audio configuration may include an identification of the type of audio encoding to send to each remote device. Registration may occur during initial scheduling of the meeting, or upon initiation of the meeting. As remote users may change their audio configuration at any time, the information identifying audio configuration may be provided at any time before and even during the meeting.

In one example, the information may identify the configuration of a remote device as a headset. If a headset is identified at decision operation 420, corresponding to “YES,” the hub captures and encodes audio information in the room using binaural recording at operation 425. The encoding may optionally include normalizing sound received from local participants that are varying distances from the microphone array at operation 430. Such normalization may be done prior to or at the same time as the encoding to help ensure voices are loud enough to be understood during the meeting by remote participants.

At operation 435, the encoding is sent to the devices of the remote participants and rendered or played at operation 440 via the remote user headsets. Method 400 returns via 445 at this point either to continue capturing and encoding at operation 425, or to decision operation 420 to check if a headset is still being used.

If a headset is not being used at decision operation 420, corresponding to “No,” the hub captures and encodes audio at operation 450 in a format suitable for rendering on speaker configuration of remote devices. At operation 455, the encoding suitable for rendering on speaker configurations is transmitted to such remote devices. The transmitted encoding may be rendered or played at operation 460 on the speakers. Rendering either continues at 450, or as shown, method 400 returns to decision operation 420 to check that the configuration has not changed for the remote device. Method 400 may proceed for each remote device, with various encodings being performed and sent to the corresponding remote devices. The encoding may be performed for discrete time periods or for selected numbers of objects that are transmitted, with decision operation 420 executed periodically to ensure the remote devices' audio configurations have not changed.

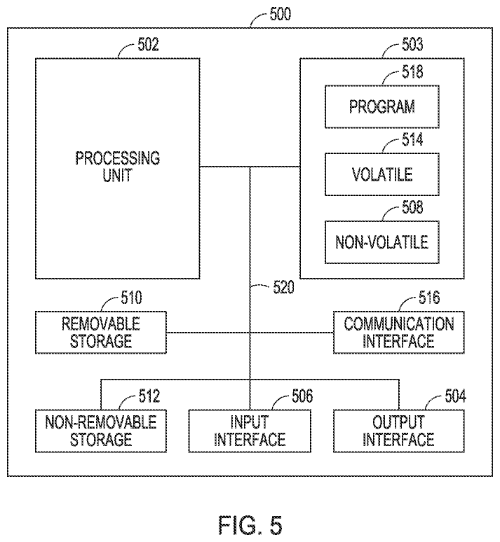

FIG. 5 is a block schematic diagram of a computer system 500 to encode sounds, perform hub device and system functions, and for performing methods and algorithms according to example embodiments. All components need not be used in various embodiments.

One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a smartphone, a tablet, smartwatch, smart storage device (SSD), or other computing device including the same or similar elements as illustrated and described with regard to FIG. 5. Devices, such as smartphones, tablets, and smartwatches, are generally collectively referred to as mobile devices or user equipment.

Although the various data storage elements are illustrated as part of the computer 500, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 503 may include volatile memory 514 and non-volatile memory 508. Computer 500 may include—or have access to a computing environment that includes—a variety of computer-readable media, such as volatile memory 514 and non-volatile memory 508, removable storage MO and non-removable storage 512. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVI)) or other optical disk storage, magnetic cassettes, magnetic tape, magnetic disk storage or other magnetic storage devices, or any other medium capable of storing computer-readable instructions.

Computer 500 may include or have access to a computing environment that includes input interface 506, output interface 504, and a communication interface 516. Output interface 504 may include a display device, such as a touchscreen, that also may serve as an input device. The input interface 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Bluetooth, or other networks. According to one embodiment, the various components of computer 500 are connected with a system bus 520.

Computer-readable instructions stored on a computer-readable medium are executable by the processing unit 502 of the computer 500, such as a program 518. The program 518 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 518 along with the workspace manager 522 may be used to cause processing unit 502 to perform one or more methods or algorithms described herein.

### Examples

A computer implemented method includes receiving sound at multiple microphones of a microphone array from multiple people at various locations about the microphone array. The received sound is encoded in at least one format capable of representing spatial locations of the multiple people. The encoded sound is transmitted in the at least one format to a remote user system capable of rendering the sound in a manner that conveys the spatial locations to a user of the remote user system.

2. The method of example 1 and further including receiving an indication of a first encoding format corresponding to the remote user system and wherein encoding the sound in at least one format capable of representing the spatial locations of the multiple people comprises encoding the sound in the first encoding format.

3. The method of example 2 and further including receiving an indication of additional remote user system specific encoding formats for multiple additional remote user system, encoding the sound in each of the received additional remote user system specific encoding formats, and transmitting corresponding additional remote user system specific encoding formats to each of the additional remote user systems.

4. The method of any of examples 1-3 wherein encoding the sound in at least one format capable of representing the spatial locations comprises encoding the sound into an object-based format.

5. The method of any of examples 1-4 wherein encoding the sound in at least one format capable of representing the spatial locations includes encoding the sound into a binaural recording format using a VBAP algorithm.

6. The method of any of examples 1-5 wherein encoding the sound in at least one format capable of representing the spatial locations includes normalizing far field and near field sound gain.

7. The method of any of examples 1-6 wherein encoding the sound in at least one format capable of representing the spatial locations includes encoding the sound using higher order ambisonics (HOA).

8. The method of any of examples 1-7 wherein encoding the sound in at least one format capable of representing the spatial locations includes encoding the sound into multiple different formats corresponding to speaker playback and headphone playback.

9. The method of any of examples 1-8 wherein transmitting the encoding sound in the at, least one format to a remote user system includes transmitting the multiple different formats to the remote user system along with identifiers of the multiple different formats to allow the remote user system to select one of the multiple formats for rendering consistent with an audio setup of the remote user system.

10. The method of example 9 wherein the remote user system includes multiple remote user systems.

11. A machine-readable storage device has instructions for execution by a processor of a machine to cause the processor to perform operations to perform any of the methods of examples 1-10.

12. A device includes a processor and a memory device coupled to the processor and having a program stored thereon for execution by the processor to perform operations to perform any of the methods of examples 1-10.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving sound at multiple microphones of a microphone array from multiple local people at various locations about the microphone array during an electronic conference;
encoding the sound in at least one format capable of representing spatial locations of the multiple people; and
transmitting, via a network, the encoded sound in the at least one format to a remote user system, participating remotely, and capable of rendering the sound in a manner that conveys the spatial locations of the local people to a user of the remote user system.

2. The method of claim 1 and further comprising:
receiving an indication of a first encoding format corresponding to the remote user system; and
wherein encoding the sound in at least one format capable of representing the spatial locations of the multiple people comprises encoding the sound in the first encoding format.

3. The method of claim 2 and further comprising:
receiving an indication of additional remote user system specific encoding formats for multiple additional remote user system;
encoding the sound in each of the received additional remote user system specific encoding formats; and
transmitting corresponding additional remote user system specific encoding formats to each of the additional remote user systems.

4. The method of claim 1 wherein encoding the sound in at least one format capable of representing the spatial locations comprises encoding the sound into an object-based format.

5. The method of claim 1 wherein encoding the sound in at least one format capable of representing the spatial locations comprises encoding the sound into a binaural recording format using a VBAP algorithm.

6. The method of claim 1 wherein encoding the sound in at least one format capable of representing the spatial locations comprises normalizing far field and near field sound gain.

7. The method of claim 1 wherein encoding the sound in at least one format capable of representing the spatial locations comprises encoding the sound using higher order ambisonics (HOA).

8. The method of claim 1 wherein encoding the sound in at least one format capable of representing the spatial locations comprises encoding the sound into multiple different formats corresponding to speaker playback and headphone playback.

9. The method of claim 1 wherein transmitting the encoding sound in the at least one format to a remote user system includes transmitting the multiple different formats to the remote user system along with identifiers of the multiple different formats to allow the remote user system to select one of the multiple formats for rendering consistent with an audio setup of the remote user system.

10. (canceled)

11. A machine-readable storage device having instructions for execution by a processor of a machine to cause the processor to perform operations to perform a method, the operations comprising:
receiving sound at multiple microphones of a microphone array from multiple local people at various locations about the microphone array during an electronic conference;
encoding the sound in at least one format capable of representing spatial locations of the multiple people; and
transmitting, via a network, the encoded sound in the at least one format to a remote user system, participating remotely, and capable of rendering the sound in a manner that conveys the spatial locations of the local people to a user of the remote user system.

12. The device of claim 11 wherein the operations further comprise:
receiving an indication of a first encoding format corresponding to the remote user system; and
wherein encoding the sound in at least one format capable of representing the spatial locations of the multiple people comprises encoding the sound in the first encoding format.

13. The device of claim 12 wherein the operations further comprise:
receiving an indication of additional remote user system specific encoding formats for multiple additional remote user system;
encoding the sound in each of the received additional remote user system specific encoding formats; and
transmitting corresponding additional remote user system specific encoding formats to each of the additional remote user systems.

14. The device of claim 13 wherein encoding the sound in at least one format capable of representing the spatial locations comprises encoding the sound into an object-based format.

15. The device of claim 13 wherein encoding the sound in at least one format capable of representing the spatial locations comprises encoding the sound into at least one of a binaural recording format using a VBAP algorithm and higher order ambisonics (HOA).

16. The device of claim 13 wherein encoding the sound in at least one format capable of representing the spatial locations comprises encoding the sound into multiple different formats corresponding to speaker playback and headphone playback.

17. The method of claim 1 wherein transmitting the encoding sound in the at least one format to a remote user system includes transmitting the multiple different formats to the remote user system along with identifiers of the multiple different formats to allow the remote user system to select one of the multiple formats for rendering consistent with an audio setup of the remote user system.

18. A device comprising:
a processor; and
a memory device coupled to the processor and having a program stored thereon for execution by the processor to perform operations comprising:
receiving sound at multiple microphones of a microphone array from multiple local people at various locations about the microphone array during an electronic conference;
encoding the sound in at least one format capable of representing spatial locations of the multiple people; and
transmitting, via a network, the encoded sound in the at least one format to a remote user system, participating remotely, and capable of rendering the sound in a manner that conveys the spatial locations of the local people to a user of the remote user system.

19. The device of claim 18 wherein the operations further comprise:
receiving an indication of a first encoding format corresponding to the remote user system; and
wherein encoding the sound in at least one format capable of representing the spatial locations of the multiple people comprises encoding the sound in the first encoding format.

20. The device of claim 19 wherein the operations further comprise:
receiving an indication of additional remote user system specific encoding formats for multiple additional remote user system;
encoding the sound in each of the received additional remote user system specific encoding formats; and
transmitting the encoded sound in a corresponding additional remote user system specific encoding formats to each of the additional remote user system based on the specific encoding format for each of the additional remote user systems.
